(19) United States
(12) Patent Application Publication
(10) Pub. No.: US 2014/0082483 A1
(43) Pub. Date: Mar. 20, 2014

(54) METHOD AND SYSTEM FOR RESTORING CLOSED WEBPAGES

(71) Applicant: Tencent Technology (Shenzhen) Company Limited, Shenzhen (CN)

(72) Inventor: XIN YANG, Shenzhen (CN)

(73) Assignee: Tencent Technology (Shenzhen) Company Limited, Shenzhen (CN)

(21) Appl. No.: 14/082,212

(22) Filed: Nov. 18, 2013

Related U.S. Application Data
(63) Continuation of application No. PCT/CN2013/081954, filed on Aug. 21, 2013.

(30) Foreign Application Priority Data
Sep. 17, 2012 (CN) 201210344234.9

(51) Int. Cl. G06F 17/22

(52) U.S. Cl. CPC G06F 17/2247
USPC 715/234

(57) ABSTRACT

A method is provided for restoring closed webpages. The method includes a browser activating a webpage restoration function based on the first closed webpage. The method also includes the browser recording in order recently closed webpages based on an order in which the webpages were closed. Further, the method includes the browser receiving a webpage restoration request. The method includes the browser restoring the recently recorded webpage based on the restoration request.

### CROSS-REFERENCES TO RELATED APPLICATIONS

This application is a continuation application of PCT Patent Application No. PCT/CN2013/081954, filed on Aug. 21, 2013, which claims priority of Chinese Patent Application No. 201210344234.9, filed on Sep. 17, 2012, the entire contents of all of which are incorporated by reference herein.

### FIELD OF THE INVENTION

The present invention generally relates to computer network technologies and, more particularly, to a method and system for restoring closed webpages.

### BACKGROUND

When a user uses a browser, the user often opens multiple webpages simultaneously and closes some webpages every now and then. During this period, the user may close a webpage accidentally or the user may need to reopen the recently closed webpage due to some reasons. Therefore, a browser with the function to restore the recently closed webpage is needed.

In the current technologies, users restore the recently closed webpage by a web address browsing history function of a history module that records websites accessed by the users. When a user needs to restore the recently closed webpage, the user first finds and clicks a bookmark history button on browser toolbar. After the user clicks “History” entry in an opened drop-down list, the user selects a webpage title that needs to be restored by clicking the corresponding webpage title based on the displayed history titles. Thus, such method for restoring the recently closed webpage requires more steps, and the corresponding operations are relatively complicated.

The disclosed method and system are directed to solve one or more problems set forth above and other problems.

### BRIEF SUMMARY OF THE DISCLOSURE

One aspect of the present disclosure includes a method for restoring closed webpages. The method includes a browser activating a webpage restoration function based on the first closed webpage. The method also includes the browser recording in order recently closed webpages based on an order in which the webpages were closed. Further, the method includes the browser receiving a webpage restoration request. The method includes the browser restoring the recently recorded webpage based on the restoration request.

Another aspect of the present disclosure includes a system for restoring closed webpages. The system includes a determination unit, a function activation unit, a webpage recording unit, a request sending unit, and a webpage restoration unit. The function activation unit is configured to activate the webpage restoration function based on the first closed webpage. The webpage recording unit is configured to record in order the recently closed webpages based on an order in which the webpages were closed. The request sending unit is configured to send a webpage restoration request based on a user's operation. The webpage restoration unit is configured to restore the recently recorded webpage from the webpage recording unit based on the restoration request.

Other aspects of the present disclosure can be understood by those skilled in the art in light of the description, the claims, and the drawings of the present disclosure.

### BRIEF DESCRIPTION OF THE DRAWINGS

In order to more clearly illustrate technical solutions of the present invention or the existing technology, the figures which are needed to be used in the description of the present invention or the existing technology are briefly described in the following. Obviously, the figures in the following description are only some embodiments of the present invention, and it is easily for those skilled in the art to obtain other figures based on the following figures without creative work.

FIG. 1 illustrates a flow diagram of an exemplary process for restoring closed webpages on a browser running on the terminal consistent with the disclosed embodiments;

FIG. 2 illustrates a framework diagram of an exemplary browser architecture consistent with the disclosed embodiments;

FIG. 3 illustrates an exemplary operating environment incorporating certain disclosed embodiments;

FIG. 4 illustrates a block diagram of an exemplary computer system consistent with the disclosed embodiments;

FIG. 5a illustrates a schematic diagram of an exemplary “Restore Webpage” button on a browser consistent with the disclosed embodiments; and

FIG. 5b illustrates a schematic diagram of another exemplary “Restore Webpage” button on a browser consistent with the disclosed embodiments.

### DETAILED DESCRIPTION

Reference will now be made in detail to exemplary embodiments of the invention, which are illustrated in the accompanying drawings.

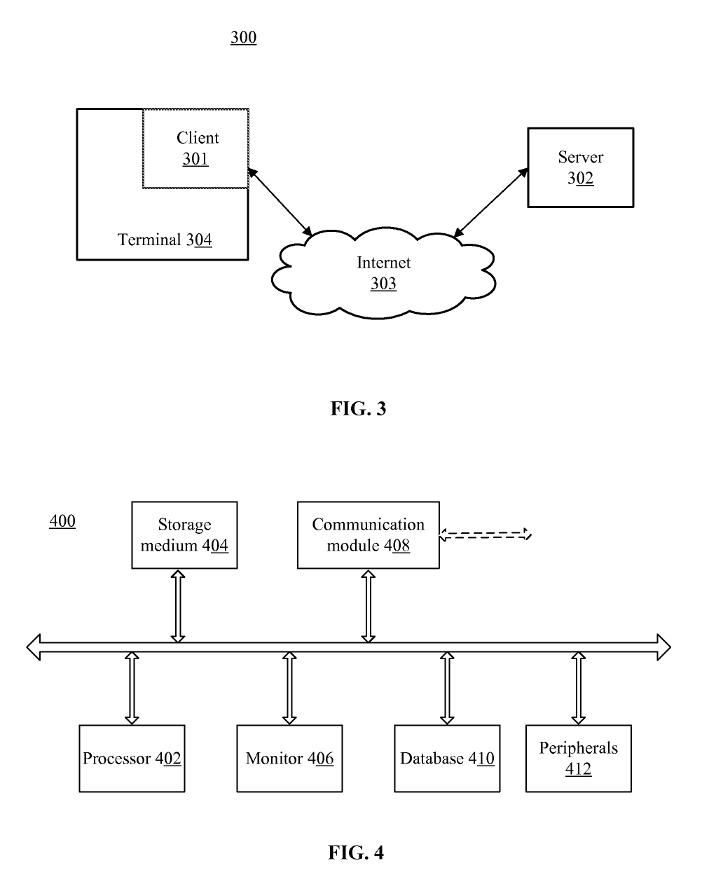

FIG. 3 illustrates an exemplary operating environment 300 incorporating certain disclosed embodiments. As shown in FIG. 3, environment 300 may include a terminal 304, the

Internet 303, and a server 302. The Internet 303 may include any appropriate type of communication network for providing network connections to the terminal 304 and the server 302 or among multiple terminals and servers. For example, Internet 303 may include the Internet or other types of computer networks or telecommunication networks, either wired or wireless.

A server, as used herein, may refer to one or more server computers configured to provide certain web server functionalities to provide certain personalized services, which may require any user accessing the services to authenticate to the server before the access. A web server may also include one or more processors to execute computer programs in parallel.

The server 302 may include any appropriate server computers configured to provide certain server functionalities, such as a file server functionality for responding a user's request for restoring webpage operations or other application server. Although only one server is shown, any number of servers can be included. The server 302 may be operated in a cloud or non-cloud computing environment.

Terminal 304 may include any appropriate type of computing devices, such as mobile phones, smart phones, tablets, notebook computers, or any type of computing platform. A terminal (e.g., terminal 304) may include one or more clients 301. The client 301, as used herein, may include any appropriate mobile application software, hardware, or a combination of application software and hardware to achieve certain client functionalities. For example, client 301 may include a browser, etc. According to actual needs in different terminals, a mobile client may be a browser installed on the terminal for browsing, including various types of existing and future browser installed on terminals. Although only one client 301 is shown in the environment 300, any number of clients 301 may be included.

Terminal 304, client 301, and/or server 302 may be implemented on any appropriate computing platform. FIG. 4 illustrates a block diagram of an exemplary computer system 400 capable of implementing terminal 304, client 301, and/or server 302.

As shown in FIG. 4, computer system 400 may include a processor 402, a storage medium 404, a monitor 406, a communication module 408, a database 410, and peripherals 412. Certain devices may be omitted and other devices may be included.

Processor 402 may include any appropriate processor or processors. Further, processor 402 can include multiple cores for multi-thread or parallel processing. Storage medium 404 may include memory modules, such as Read-only memory (ROM), Random Access Memory (RAM), flash memory modules, and erasable and rewritable memory, and mass storages, such as CD-ROM, U-disk, and hard disk, etc. Storage medium 404 may store computer programs for implementing various processes, when executed by processor 402.

Further, peripherals 412 may include I/O devices such as keyboard and mouse, and communication module 408 may include network devices for establishing connections through the communication network. Database 410 may include one or more databases for storing certain data and for performing certain operations on the stored data, such as database searching.

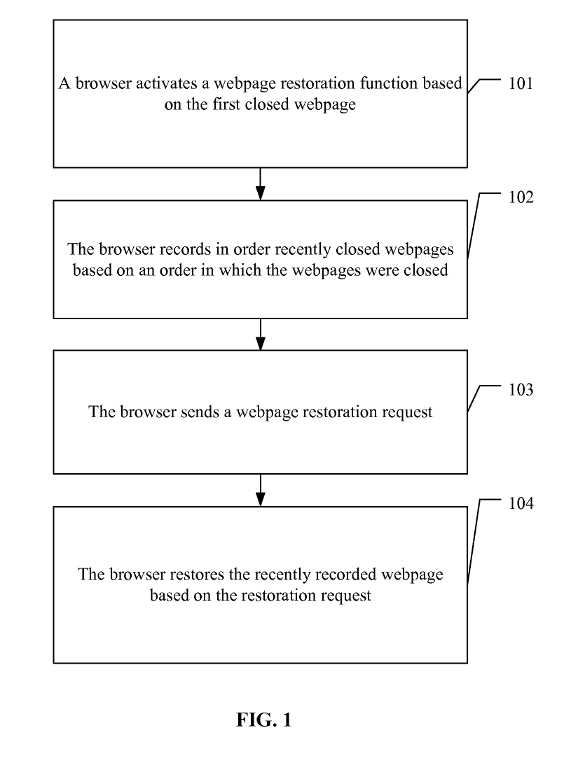

In operation, terminals/clients and servers 302 may interact with each other to restores closed webpages to the user(s) of the terminals. FIG. 1 illustrates a flow diagram of an exemplary process for restoring closed webpages on a browser running on the terminal consistent with the disclosed embodiments.

As shown in FIG. 1, the process for restoring closed webpages on a browser may include the following steps:

Step 101: a browser activates a webpage restoration function based on the first closed webpage.

The browser activates a webpage restoration function based on the first closed webpage. Specifically, before the browser activates the webpage restoration function in Step 101, when the user closes a webpage from opened webpages for the first time, the browser determines whether the first closed webpage is a start webpage. A start webpage, as used herein, may refer to a default page or a home page displayed by the browser when a browser window is opened. If it is determined that the first closed webpage is not a start webpage, the browser activates the webpage restoration function.

Step 102: the browser records in order recently closed webpages based on an order in which the webpages were closed.

The webpages, as used herein, may refer to multiple tabs displayed by one or more browser windows. Specifically, the browser records in order recently closed webpages based on an order in which the webpages were closed by pushing the webpages into a stack. The stack may be a last input first output (LIFO) structure, that is, a webpage that is added last to the stack is taken out first.

The stack may have certain limitations on the total number of closed pages to be recorded. For example, at most 16 recently closed webpages may be recorded, that is, the user may restore the last 16 closed webpages. It should be understood that the maximum number of recently closed webpages that can be recorded may be adjusted based on users' needs, browser settings and system configuration (e.g., memory capacity). There are no specific limitations on the maximum number of recorded recently closed webpages. The user may define the maximum number of recently closed webpages via a user interface provided by the browser.

In addition, when closing a webpage every time, the browser determines whether the closed webpage is a start webpage. If it is determined that the closed webpage is not a start webpage, the browser records the closed webpage. That is, the browser does not restore the start webpage.

Step 103: the browser sends a webpage restoration request.

Specifically, the number of webpage restoration requests sent by the browser may be more than one. The user may click a “Restore Webpage” button to send a webpage restoration request. The “Restore Webpage” button may be placed on a toolbar of the browser. For example, the “Restore Webpage” button may be located on the right side of the browser toolbar. Every time the user clicks the “Restore Webpage” button, a webpage restoration request is sent.

Step 104: the browser restores the recently recorded webpage based on the restoration request.

Every time the browser receives the webpage restoration request, the browser restores the recently recorded webpage based on the received webpage restoration request. The browser may restore all recorded webpages based on the above webpage restoration pattern. That is, a user may click the “Restore Webpage” button to restore a recently recorded webpage. Clicking the button repeatedly goes back through the recorded webpages, from most to least recent. The recorded webpages to be restored, as used herein, may refer to one or more tabs recorded by the browser.

Further, the recorded webpages to be restored may also refer to one or more tabs recorded by the browser after one or more browser windows are closed. That is, the user may restore one or more closed webpages in one or more closed browser windows. For example, after a user closes an entire window containing one or more webpages, the user can still restore the recently closed webpages in the previous closed window by clicking the “Restore Webpage” button on the current window. In addition to restoring the webpages of the previous closed window, the user can also restore the webpages of all closed windows from the last time by clicking the “Restore Webpage” button repeatedly on the current window.

Specifically, when the browser restores the recently recorded webpages based on the restoration request, the topmost recorded webpage which is added last is taken out and restored first. Therefore, the restored webpage is the recently closed webpage based on the restoration request.

Further, after the browser restores the recently recorded webpages based on the restoration request in Step 104, the browser also determines whether there is a webpage recorded in the current history. If it is determined that there is no webpage recorded in the current history, the browser closes the webpage restoration function. The browser needs to determine whether there is a webpage recorded in the current history after restoring a webpage every time, therefore the browser can close timely the webpage restoration function.

Further, when the webpage restoration function is closed, the corresponding “Restore Webpage” button is grayed out. That is, the “Restore Webpage” button is disabled. A disabled button is unusable and un-clickable because there is no closed webpage recorded in the current history. When the webpage restoration function is not activated, webpage restoration function is in a closed status.

Finally, when the browser is closed, the browser clears all current webpage history, thereby preventing unnecessary memory consumption and avoiding impact on the next operation.

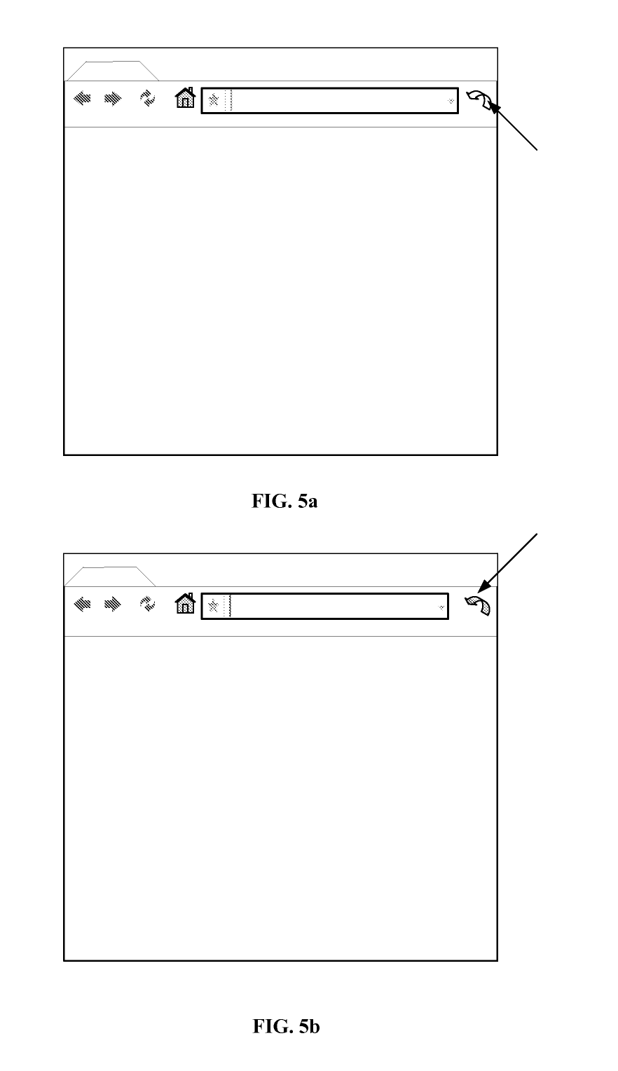

FIG. 5a illustrates a schematic diagram of an exemplary “Restore Webpage” button on a browser consistent with the disclosed embodiments. As shown in FIG. 5a, the “Restore Webpage” button may be placed on a command bar of the browser. The command bar is located at the upper-right side of the browser window. A user can customize the “Restore Webpage” button to suit his/her preferences (e.g., text label, icon, size, etc.). For example, the user clicks the command bar and points to customize entry, and then selects “text label” to display or hide text label on the “Restore Webpage” button, selects “icon” to change the icon type of the “Restore Webpage” button, or selects “resize” to resize the “Restore Webpage” button. The user may also change the “Restore Webpage” button position. The user clicks the command bar and points to customize entry, and then clicks “Restore Webpage Button before Address Bar” to switch between showing the “Restore Webpage” button on the left of the Address bar and showing the “Restore Webpage” button on the right of the Address bar.

FIG. 5b illustrates a schematic diagram of another exemplary “Restore Webpage” button on a browser consistent with the disclosed embodiments. As shown in FIG. 5b, the “Restore Webpage” button may be located at the right side of the browser. The “Restore Webpage” button is grayed out, so the user can no longer click on the “Restore Webpage” button.

Based on the above descriptions, the method for restoring closed webpages on a browser may restore the recently closed webpages quickly by simply clicking a “Restore Webpage” button. The corresponding operations are very convenient and efficient. Thus, the method provides users with a simple way to restore the recently closed webpages quickly.

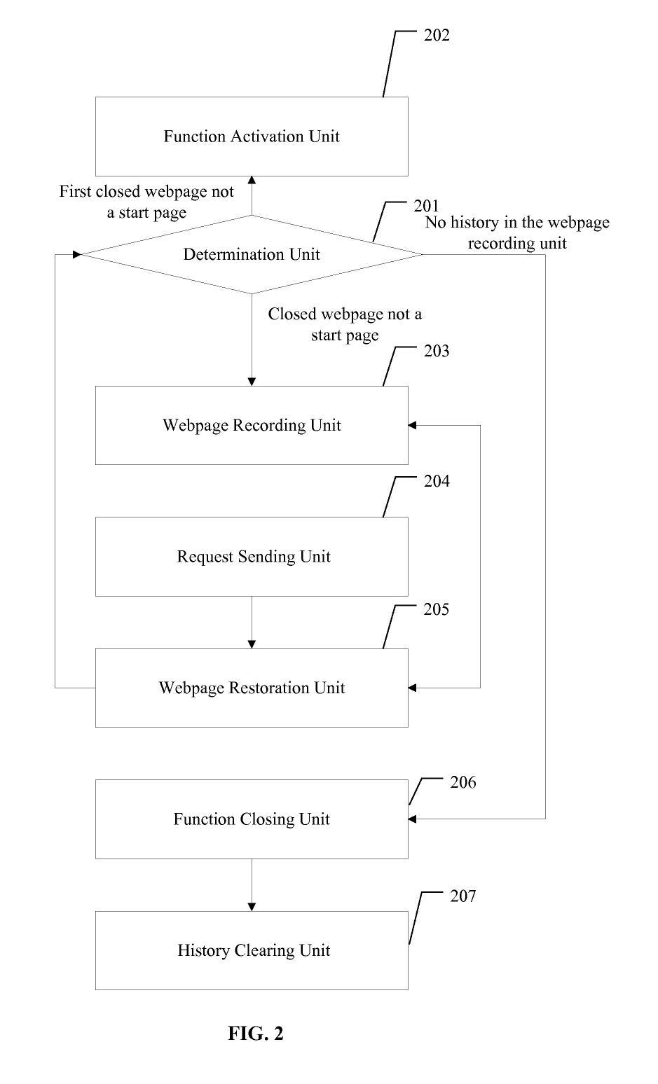

FIG. 2 illustrates a framework diagram of an exemplary browser architecture consistent with the disclosed embodiments. As shown in FIG. 2, the browser includes a determination unit 201, a function activation unit 202, a webpage recording unit 203, a request sending unit 204, a webpage restoration unit 205, a function closing unit 206, and a history clearing unit 207.

The determination unit 201 is configured to determine whether the first closed webpage is a start webpage. The function activation unit 202 is configured to activate a webpage restoration function when it is determined that the first closed webpage is not a start webpage. When the webpage restoration function is activated, the corresponding “Restore Webpage” button is available.

The webpage recording unit 203 is configured to record the closed webpage when it is determined that the closed webpage is not a start webpage. The webpage recording unit 203 records in order recently closed webpages based on an order in which the webpages were closed by pushing webpages into a stack. The stack may have a last input first output (LIFO) structure or other structures, so long as a webpage that is added last to the stack is taken out first. The stack may have a maximum number of webpages to be recorded in the stack. For example, at most 16 recently closed webpages may be recorded. It should be understood that the maximum number of recently closed webpages that can be recorded may be adjusted based on users' needs, browser settings and system configuration (e.g., memory capacity). There are no specific limitations on the maximum number of recorded recently closed webpages.

The request sending unit 204 is configured to send a webpage restoration request based on a user's operation. The number of webpage restoration requests sent from a browser may be more than one. The user may click the “Restore Webpage” button to send a webpage restoration request. The “Restore Webpage” button is located on the right side of the browser toolbar. Every time the user clicks the “Restore Webpage” button, a webpage restoration request is sent. Every time a webpage restoration request is sent, the browser restores a recently recorded webpage based on the received webpage restoration request. The browser may restore all recorded webpages based on the above webpage restoration pattern.

The webpage restoration unit 205 is configured to take out and restore the recently recorded webpage from the webpage recording unit 203 based on the webpage restoration request. When the webpage restoration unit 205 restores the recently recorded webpage based on the webpage restoration request, the topmost recorded webpage which is added last is taken out and restored first. Therefore, the restored webpage is the recently closed webpages based on the webpage restoration request.

In addition, the determination unit 201 is also configured to, after the webpage restoration unit 205 restores the recently recorded webpage every time, determine whether there is a webpage recorded in the current history of the webpage recording unit 203. If it is determined that there is no webpage recorded in the current history of the webpage recording unit 203, the webpage restoration function is closed.

The function closing unit 206 is configured to close the webpage restoration function when it is determined that there is no webpage recorded in the current history. The function closing unit 206 is also configured to set the corresponding “Restore Webpage” button gray when the webpage restoration function is closed. That is, the “Restore Webpage” button is disabled. A disabled button is unusable and un-clickable because there is no closed webpage recorded in the current history. When the webpage restoration function is not activated, the webpage restoration function is in a closed status.

The history clearing unit 207 is configured to, when the browser is closed, clear all current webpage history, thereby preventing unnecessary memory consumption and avoiding impact on the next operation.

Based on the above descriptions, the browser may restore the recently closed webpages quickly by the user simply clicking a “Restore Webpage” button. The operations are very convenient and efficient.

It should be noted that, in the above browser for restoring closed webpages, each functional unit is listed only for illustrative purposes. In practical applications, the above functions are implemented by different functional units according to the needs. That is, the internal structure of the browser for restoring closed webpages is divided into different functional units to complete all or part of the functions described above.

Those skilled in the art should understand that all or part of the steps in the above method may be executed by relevant hardware instructed by a program, and the program may be stored in a computer-readable storage medium such as a read only memory, a magnetic disk, a Compact Disc (CD), and so on.

The embodiments disclosed herein are exemplary only and not limiting the scope of this disclosure. Without departing from the spirit and scope of this invention, other modifications, equivalents, or improvements to the disclosed embodiments are obvious to those skilled in the art and are intended to be encompassed within the scope of the present disclosure.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

By using the disclosed method and system for restoring closed webpages, a browser activates a webpage restoration function based on the first closed webpage. The browser also records in order recently closed webpages based on an order in which the webpages were closed. Further, the browser sends a webpage restoration request. The browser restores the recently recorded webpage based on the restoration request. The browser may restore the recently closed webpages quickly by the user simply clicking a “Restore Webpage” button. The corresponding operation process is very convenient and efficient.

What is claimed is:

1. A method for restoring closed webpages on a browser running on a terminal, comprising:
activating, by a browser, a webpage restoration function based on the first closed webpage;
recording, by the browser, in order recently closed webpages based on an order in which the webpages were closed;
receiving, by the browser, a webpage restoration request; and
restoring, by the browser, the recently recorded webpage based on the webpage restoration request.

2. The method according to claim 1, wherein:
the browser records in order the recently closed webpages based on an order in which the webpages were closed by pushing the webpages into a stack.

3. The method according to claim 1, further including:
determining whether the first closed webpage is a start webpage; and
activating the webpage restoration function when it is determined that the first closed webpage is not a start webpage.

4. The method according to claim 1, further including:
determining whether the first closed webpage is a start webpage; and
recording the closed webpage when it is determined that the closed webpage is not a start webpage.

5. The method according to claim 1, further including:
determining whether there is a webpage recorded in the current history; and
closing the webpage restoration function when it is determined that there is no webpage recorded in the current history.

6. The method according to claim 5, further including:
disabling the corresponding “Restore Webpage” button when the webpage restoration function is closed.

7. The method according to claim 6, further including:
clearing all current webpage history when the browser is closed.

8. The method according to claim 2, further including:
setting a maximum number of recently closed webpages to be recorded in the stack as 16.

9. A system for restoring recently closed webpages, comprising:
a function activation unit configured to activate a webpage restoration function based on the first closed webpage;
a webpage recording unit configured to record in order the recently closed webpages based on an order in which the webpages were closed;
a request sending unit configured to send a webpage restoration request based on a user's operation; and
a webpage restoration unit configured to restore the recently recorded webpage from the webpage recording unit based on the webpage restoration request.

10. The system according to claim 9, wherein:
the webpage recording unit records in order the recently closed webpages by pushing the webpages into a stack.

11. The system according to claim 9, further including:
a determination unit configured to determine whether the first closed webpage is a start webpage, wherein, when it is determined that the first closed webpage is not a start webpage, the function activation unit activates the webpage restoration function.

12. The system according to claim 11, wherein:
the determination unit is configured to determine whether the closed webpage is a start webpage; and
when it is determined that the closed webpage is not a start page, the webpage recording unit records the closed webpage.

13. The system according to claim 11, wherein:
the determination unit is further configured to determine whether there is a webpage recorded in the current history of the webpage recording unit; and
the function closing unit is further configured to close the webpage restoration function when it is determined that there is no webpage recorded in the in the current history.

14. The system according to claim 13, wherein:
the function closing unit is further configured to disable the “Restore Webpage” button when the webpage restoration function is closed.

15. The system according to claim 14, further including:
a history clearing unit configured to, when the browser is closed, clear all current webpage history.

16. The system according to claim 10, wherein:
a maximum number of recently closed webpages to be recorded in the stack is set to 16.
